(19) United States
(12) Patent Application Publication
(10) Pub. No.: US 2015/0120528 A1
(43) Pub. Date: Apr. 30, 2015

(54) ELECTRONIC DONATION MANAGEMENT SYSTEM AND METHOD

(71) Applicant: GRACIOUSFROG COMPANY LIMITED, Hong Kong (HK)

(72) Inventor: Rick Li-Kei Tsing, Hong Kong (HK)

(73) Assignee: GRACIOUSFROG COMPANY LIMITED

(21) Appl. No.: 14/493,350

(22) Filed: Sep. 23, 2014

(30) Foreign Application Priority Data
Oct. 31, 2013 (HK) 13112286.3

(51) Int. Cl. G06Q 30/02

(52) U.S. Cl. CPC G06Q 30/0279; G06Q 40/025
USPC 705/38

(57) ABSTRACT

An electronic donation management system includes: a server, the server including a processor; and a platform in communication with the server, the platform being connected with the Internet and accessible to a plurality of users through the Internet. The platform is a web application being configured to generate a website and a mobile application. The platform is configured to receive donation and loan related data from the users and send the data to the server. The server is configured to store the data, to grant appropriate memberships to the users respectively, and to activate functions that correspond to the memberships for the users respectively. The processor is configured to make calculations based on the data and make donation and loan related decisions according to the calculations. An electronic donation management method is also provided.

### CROSS-REFERENCE TO RELATED APPLICATIONS

This application claims the benefit of Hong Kong Patent Application No. HK13112286.3 filed on Oct. 31, 2013; the contents of which is hereby incorporated by reference.

### FIELD OF THE PATENT APPLICATION

The present patent application generally relates to information technologies and more specifically to an electronic donation management system and an electronic donation management method.

### BACKGROUND

In the world of business or philanthropy, there are often donations given by donors. The donors may donate money to a specific organization. The specific organization, managing the donation fund, may give loans to borrowers based on particular circumstances and reasons of the borrowers. It is desired to effectively manage the donation fund and put the money into the most appropriate projects. It is also desired to automate the process of micro-finance nowadays and to have a system for sharing and managing donations to offer sustainable assistance to people in need.

After the borrowers repay the debts, there will be an interest or bonus on top of the amount of money loaned to the borrowers. It is desired to have a systematic and efficient way to distribute this bonus among the donors.

### SUMMARY

The present patent application is directed to an electronic donation management system. In one aspect, the system includes: a server, the server including a processor; and a platform in communication with the server, the platform being connected with the Internet and accessible to a plurality of users through the Internet. The platform is a web application being configured to generate a website and a mobile application. The platform is configured to receive donation and loan related data from the users and send the data to the server. The server is configured to store the data, to grant appropriate memberships to the users respectively, and to activate functions that correspond to the memberships for the users respectively. The processor is configured to make calculations based on the data and make donation and loan related decisions according to the calculations.

The server may be configured to activate one or multiple memberships for each user among a donor membership, a borrower membership, and an ordinary member membership. The server may be configured to generate a donation interface on the platform. The donation interface may be configured to accept a donation payment from a user through an online payment gateway. The server may be configured to grant the user the donor membership, send the user a monthly report on a repayment record and a bonus that the user has gained, and send the user a real-time record of repayments and bonus gained from the donation that the user has made.

The server may be configured to generate a loan application interface, the load application interface being configured to accept a loan application from a user. The server may be configured to grant the user the borrower membership, and to allow other users to search and vote on the loan application. The processor may be configured to count the number of votes approving the loan application and the number of votes disapproving the loan application, and to determine whether to approve the loan application according to predetermined criteria based on the numbers. The predetermined criteria may vary with the amount of loan being applied for in the loan application.

The processor may be configured to distribute a bonus resulted from repayment by users with the borrower membership among users with the donor membership based on a total amount of donation and an amount of individual donation that each user with the donor membership contributes to the total amount.

In another aspect, the present patent application provides an electronic donation management method. The method includes: generating a website and a mobile application with a platform; receiving donation and loan related data from a plurality of users and sending the data to a server with the platform; storing the data, granting appropriate memberships to the users respectively, and activating functions that correspond to the memberships for the users respectively with the server; and making calculations based on the data and making donation and loan related decisions according to the calculations with a processor of the server. The platform is in communication with the server, connected with the Internet, and accessible to a plurality of users through the Internet.

The method may further include activating one or multiple memberships for each user among a donor membership, a borrower membership, and an ordinary member membership with the server. The method may further include generating a donation interface on the platform with the server, the donation interface being configured to accept a donation payment from a user through an online payment gateway. The method may further include granting the user the donor membership, sending the user a monthly report on a repayment record and a bonus that the user has gained with the server, and sending the user a real-time record of repayments and bonus gained from the donation that the user has made.

The method may further include generating a loan interface with the server, the load interface being configured to accept a loan application from a user. The method may further include granting the user the borrower membership and allowing other users to search and vote on the loan application with the server. The method may further include counting the number of votes approving the loan application and the number of votes disapproving the loan application and determining whether to approve the loan application according to predetermined criteria based on the numbers with the processor. The predetermined criteria may vary with the amount of loan being applied for in the loan application.

The method may further include distributing a bonus resulted from repayment by users with the borrower membership among users with the donor membership based on a total amount of donation and an amount of an individual donation that each user with the donor membership contributes to the total amount with the processor.

In yet another aspect, the present patent application provides an electronic donation management system that includes: a server, the server including a processor; and a platform in communication with the server, the platform being connected with the Internet and accessible to a plurality of users through the Internet. The platform is a web application being configured to generate a website and a mobile application. The platform is configured to receive donation and loan related data from the users and send the data to the server. The server is configured to store the data, to grant appropriate memberships to the users respectively, to activate functions that correspond to the memberships for the users respectively, and to allow one user to send a friend request to another user. The processor is configured to make calculations based on the data and make donation and loan related decisions according to the calculations. The donation and loan related decisions include whether to approve a loan application filed by a borrower, and how to distribute a bonus from a loan among a plurality of donors.

The server may be configured to accept a loan application from a user through a loan application interface and to allow other users to vote on the loan application, and the processor may be configured to count the number of votes approving the loan application and the number of votes disapproving the loan application and to determine whether to approve the loan application according to a criteria based on the numbers.

### BRIEF DESCRIPTIONS OF THE DRAWINGS

FIG. 1A is a block diagram of an electronic donation management system in accordance with an embodiment of the present patent application.

FIG. 1B shows the information inflow and outflow of a platform in the electronic donation management system depicted in FIG. 1A.

FIG. 2A shows features available for members of each type of membership in the electronic donation management system depicted in FIG. 1A.

FIG. 2B is a flowchart illustrating information collected for members of different memberships in the electronic donation management system depicted in FIG. 1A.

FIG. 3 is a flow chart illustrating the process of creating a loan application page with the electronic donation management system depicted in FIG. 1A.

FIG. 4 illustrates a calculation system for distributing bonus among respective donors in the electronic donation management system depicted in FIG. 1A.

FIG. 5 illustrates a public loan assessment process executed by the electronic donation management system depicted in FIG. 1A.

### DETAILED DESCRIPTION

Reference will now be made in detail to a preferred embodiment of the electronic donation management system and method disclosed in the present patent application, examples of which are also provided in the following description. Exemplary embodiments of the system and method disclosed in the present patent application are described in detail, although it will be apparent to those skilled in the relevant art that some features that are not particularly important to an understanding of the system and method may not be shown for the sake of clarity.

Furthermore, it should be understood that the system and method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

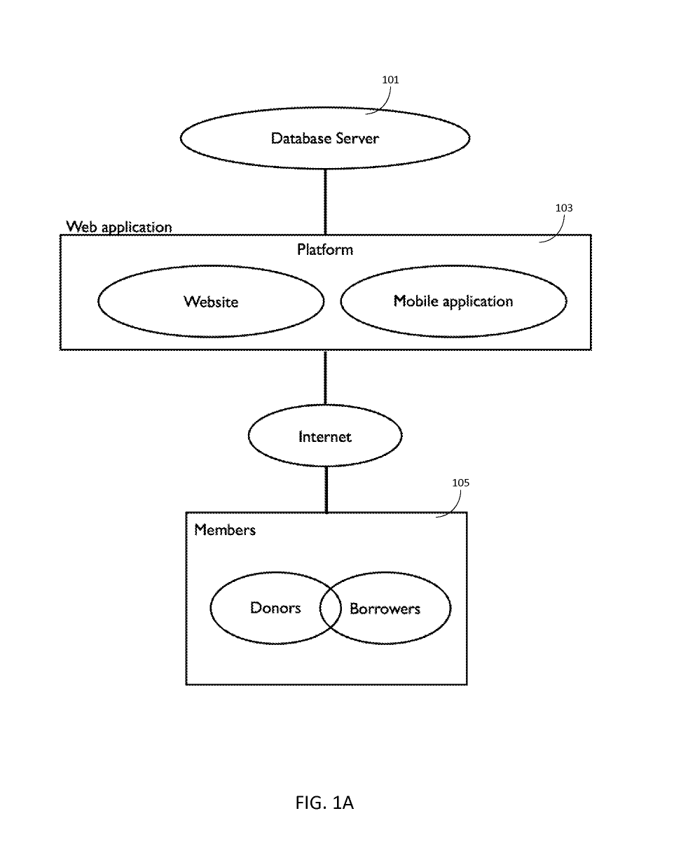

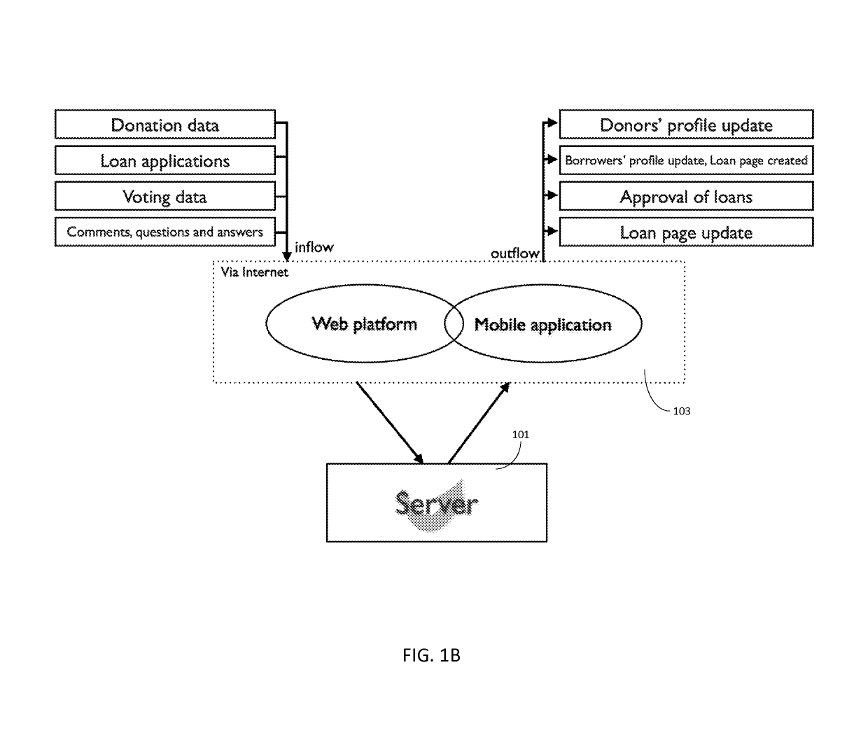

FIG. 1A is a block diagram of an electronic donation management system in accordance with an embodiment of the present patent application. Referring to FIG. 1A, the electronic donation management system includes a server 101 and a platform 103 in communication with the server. The platform 103 is connected with the Internet. Members 105 of the system are connected to the platform 103 through the Internet. The platform 103 in this embodiment is a web application. The members 105 can access the web application through the Internet.

In this embodiment, the web application is configured to generate a website and a mobile application. As a result, a user can access the web application through a computer running a desktop operating system or a mobile device such as an iOS or Android phone. The web application may be hosted on the server 101 or hosted on a server that is connected to the server 101. The server 101 is a database server that includes a processor. The electronic donation management system processes donation management mainly through the platform 103, i.e. the web application, such as processing applications for loan, donations, loan assessments, and etc.

Among the members 105, there are 3 types of basic memberships: ordinary member (OM), donors (DO) and borrowers (BO). All possible memberships include OM, OM+DO+BO, OM+DO, and OM+BO. For example, if a member is an OM+DO+BO, it means this member is an OM, a DO, and a BO at the same time. Information is collected and sent based on the membership type. Information is stored in the database server 101, which can be a cloud server or a local server. The database server 101 may be one server or a server cluster that includes multiple servers wirelessly connected with each other. Features of the electronic donation management system can be locked or unlocked to members of a specific type of membership. In this embodiment, the server 101 is configured to activate one or multiple memberships for each user among the donor membership, the borrower membership, and the ordinary member membership.

The platform 103 is accessible to the public via the web application, which generates the web site and the mobile application accessible to the public, a Member, a Donor, a Borrower and a License Administrator, and enables all of these parties to interact on the platform. The platform 103 is an open and interactive platform for managing a fund. The platform 103 is open for any interested user to register on. Once becoming a member of the platform 103, the user can make donation to the fund managed through the platform, file a loan application to the platform, and get a loan from the fund. Further the member can participate in the decision process of approving or disapproving a loan application by browsing, commenting and voting on each loan application. The member may access the platform 103 through the website or the mobile application with a PC or a mobile device such as a tablet running iOS or Android, via the Internet or a mobile network such as GSM, GPRS, CDMA, and WiFi networks.

When a user presses a “Register” button, a request for registration is sent to the platform 103. After receiving the request, the platform 103 is configured to send a response to the user and display a registration page on the user's device. There are multiple fields on the registration page for collecting the registration information from the user, including name, address, phone number, email address and so on. After the user inputs all the information, the platform 103 collects the information from the registration page and creates a user record in the database server 101, and the user becomes a member.

In this embodiment, the platform 103 is configured to receive donation and loan related data from the users and send the data to the server 101. The server 101 is configured to store the data, to grant appropriate memberships to the users respectively, and to activate functions that correspond to the memberships for the users respectively. The processor is configured to make calculations based on the data and make donation and loan related decisions according to the calculations.

FIG. 1B shows the flow direction of the information collected and generated through the Internet to the platform 103. The information the users input to the platform 103 are stored in the server 101. Further processing generates respective information to be shown on the platform 103. For example, an action of donation through online payment gateway may be recorded in the server 101, and then the server 101 produces a donation record and activates the donor membership of the user. In this embodiment, the server is configured to generate a donation interface on the platform, the donation interface being configured to accept a donation payment from a user through an online payment gateway. The server is configured to grant the user the donor membership, send the user a monthly report on a repayment record and a bonus that the user has gained, and send the user a real-time record of repayments and bonus gained from the donation that the user has made.

An action of applying for a loan may be recorded in the server 101, and then the server 101 creates a loan page for the application, activates a borrower's membership of the user, and updates the application history on the user's profile. An action of casting a vote on a loan application may be recorded by the server 101, and then the server 101 calculates and generates a final approval result. Actions of giving comments, asking question and answering questions by members on a loan page may be recorded by the server 101, and then the server 101 updates the loan page with the input and activates certain functions such as replying to the comments or answering the questions. In this embodiment, the server is configured to generate a loan application interface, the load application interface being configured to accept a loan application from a user. The server is configured to grant the user the borrower membership, and to allow other users to search and vote on the loan application.

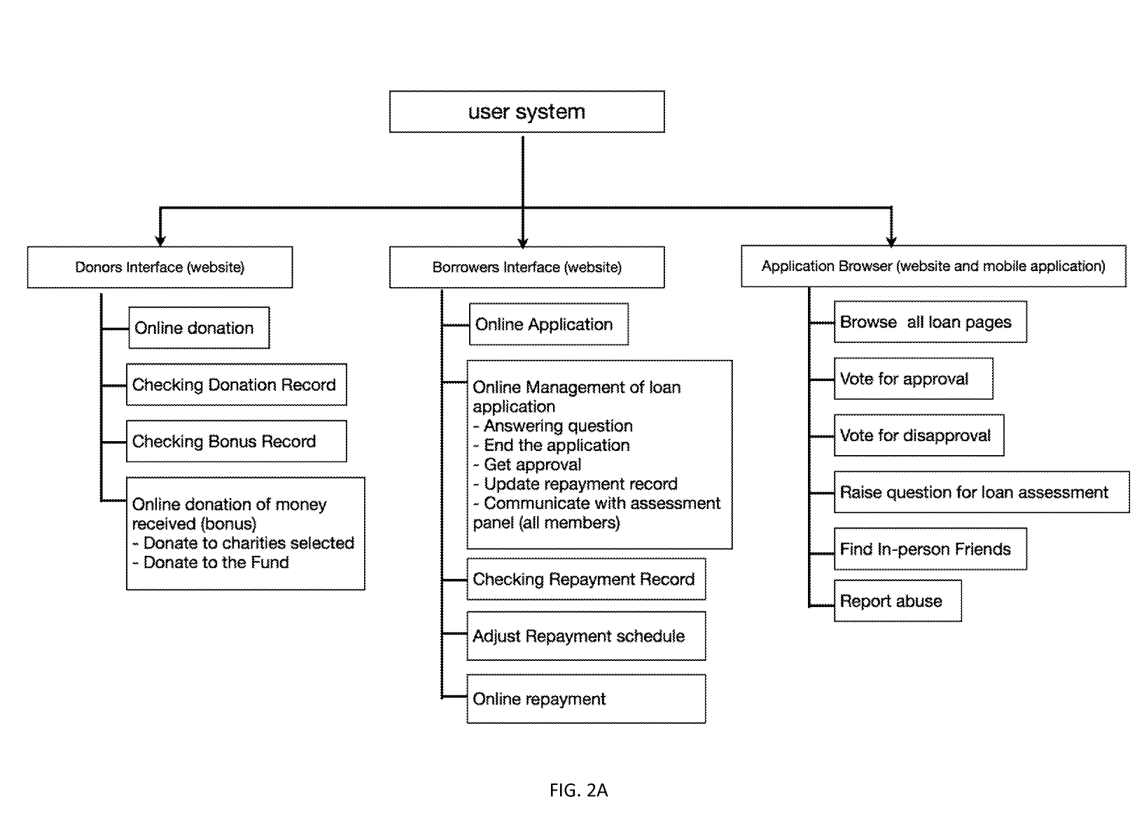

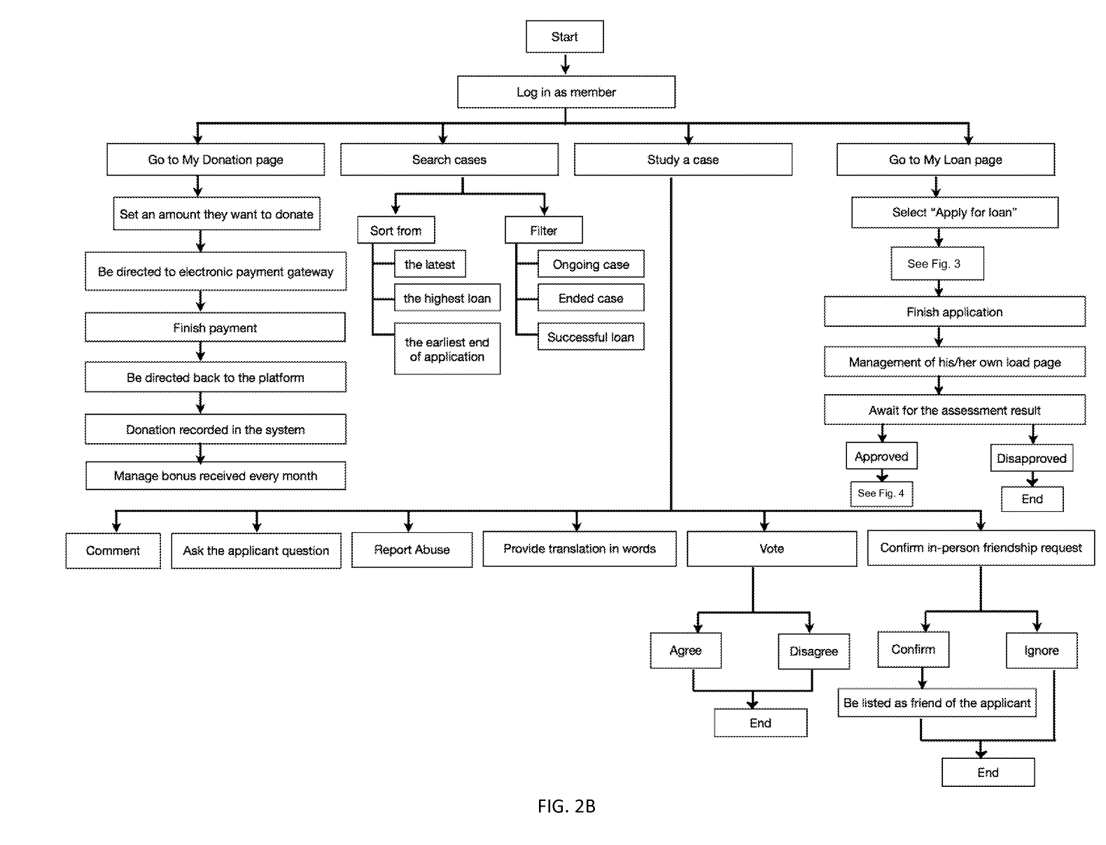

FIG. 2A shows features available for members of each type of membership. Referring to FIG. 2A, the user system is open to all members and functions are activated when the users take certain actions. More specifically, when a user accesses a donor interface to make a donation, other functions of the donor interface are activated for this user. When a user accesses a borrow interface to apply for a loan, other functions of the borrower interface are activated for this user. The application browser can be accessed by any member and any member can use all functions under the application browser.

FIG. 2B is a flowchart illustrating information collected for members of different memberships. The flowchart describes how a member achieves a certain membership by specific steps and actions. The system is open for a user to register and log in as a member. All members of the system, when not having executed any donation or loan application, are ordinary members. The ordinary members may browse loan applications on the platform, review the applications, vote on the applications, raise questions regarding the applications, make comments and evaluations on the applications, and report irregular situations, such as a dishonest abuse. As a member, the user may browse the cases on the platform, search cases by sorting and/or filtering, and select a case and study the information of the application. The user can input a question to ask the borrower. The user can input a comment. The user can report abuse by sending an email if the user knows any dishonest conduct. The user can feel free to make translation of a video into different languages and leave it as a comment. If an in-person friend request is sent to the user, the user can choose to confirm and link his/her profile with the application (representing the feature of endorsing an applicant), or decline the request. The user can select “approve” or “disapprove” to vote on a loan application. A message box will come up asking for confirmation. The electronic donation management system may appoint a specific loan application examiner for all loan applications, or randomly pick a user for each loan application. The loan application examiner may have interviews with the loan applicant or the friends of the loan applicant and record his/her opinion about the loan application in the system which can be retrieved by a potential donor. It is noted that the examiner should be an administrator, and the system would appoint/randomly select any application regularly for review.

In this embodiment, the electronic donation management system manages one or multiple funds or fund accounts. A donor may donate money to any of these funds. To become a donor, the user goes to the “My donation” page, select the amount of donation, and click “pay”, and the system will direct him/her to an online payment gateway, such as a bank card, credit card, POS terminal, or a web based payment gateway. After the online transaction process, his/her donation will be recorded in the system and the user will successfully become a donor and more functions are activated for the user. The donor can receive a monthly report on the repayment record and the bonus he/she has gained. The donor may decide to donate the bonus to the charities that he/she selects or to the fund. Once a user makes a donation, he/she will have a permanent donor membership. The donating history of the user is kept in the profile of the user. The donor can make multiple donations after making a particular donation.

In this embodiment, the member may send a donation request to the platform. After receiving the donation request, the platform sends a response to the member through the Internet, which generates a page on the display of the member's user device. The page includes fields for information such as donation amount, and how to distribute the bonus (for example, whether to put the bonus back into the fund or donate the bonus to specific philanthropic parties). After the user presses the “confirm” button, the donation request, being processed by the CPU of the user device, is transmitted to the platform through the Internet. The platform is configured to update the user's record based on the information, including updating the membership of the user to a donor membership. At the same time, the platform is configured to respond to the donor's confirmation, send data to the user device of the donor, and update the display of the user device to a donation confirmation page.

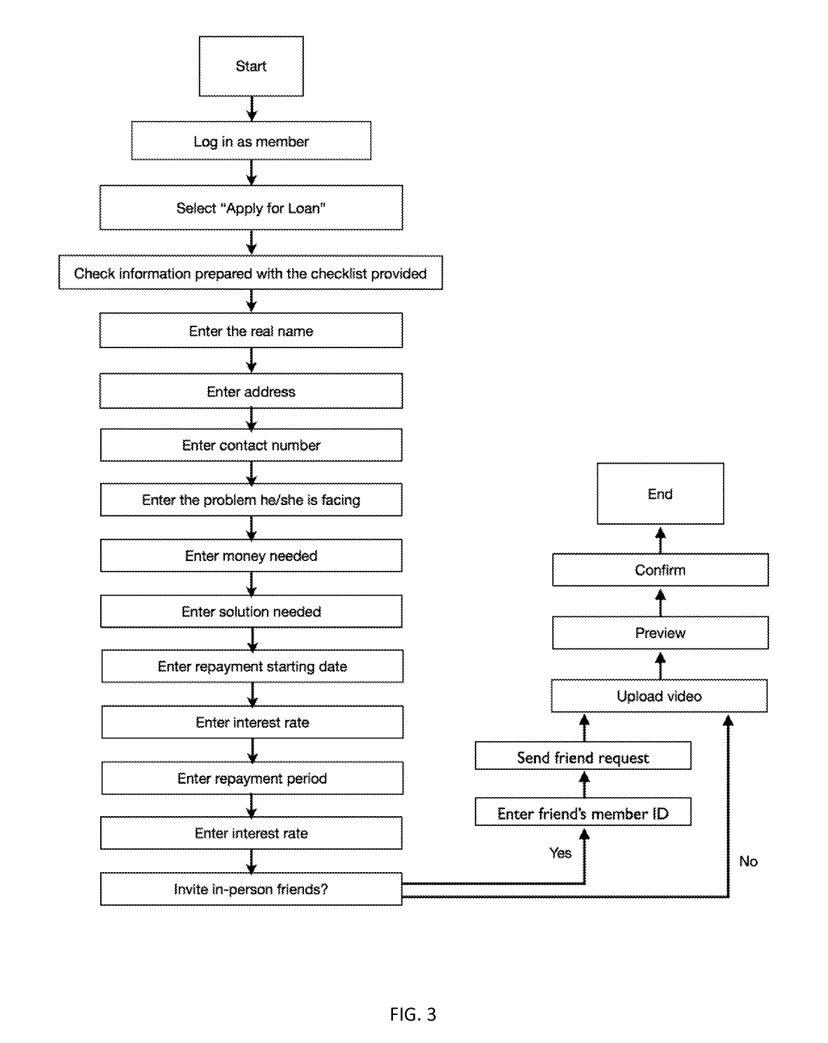

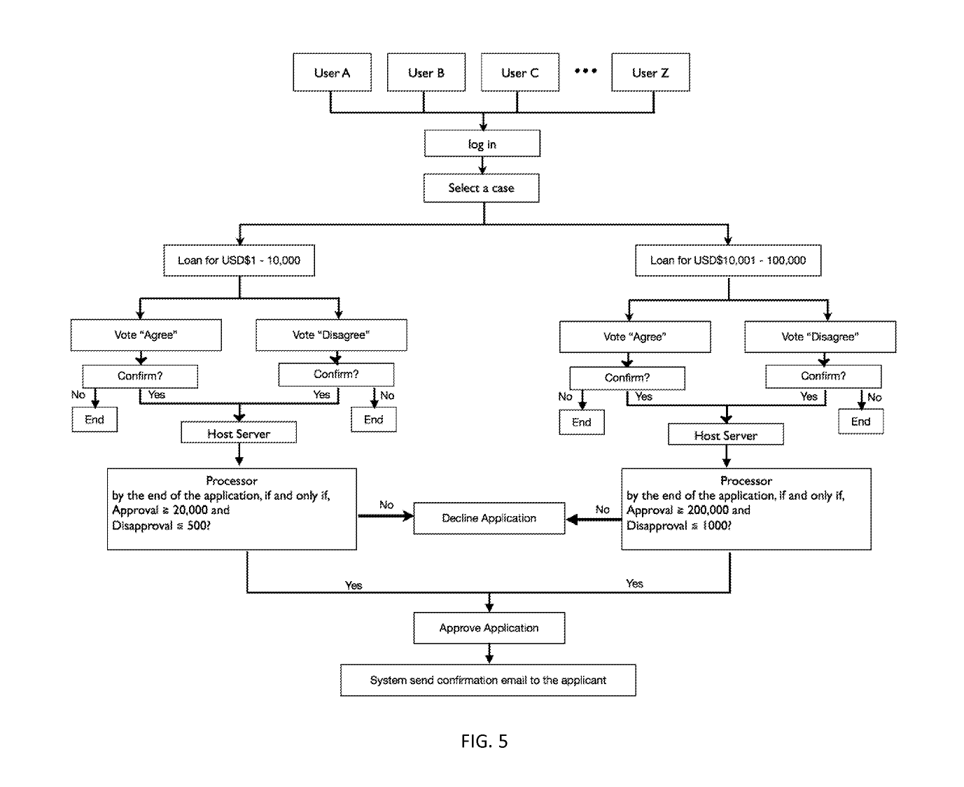

To become a borrower, the user goes to the “My loan” page, select “Apply for loan”, and follow the steps shown in FIG. 3. When the application is submitted, its loan page is immediately activated and the applicant becomes a borrower. Other users can search the loan application. The borrower starts to manage the page. By the end of the application, the voting functions of management of the loan page will be deactivated and the borrower will received the result via email. As shown in FIG. 5, if the application fulfills certain requirements, the application can be approved and the transfer process will be arranged. If the application fails, the application comes to an end and it will stay in the application history of the user.

In this embodiment, the member sends a loan request to the platform. After receiving the loan request, the platform sends a response to the member through the Internet, which generates a loan application page on the display of the member's user device. It is noted that the approval of an administrator is needed in this process. The platform may retrieve user data from the database server and display the information on the user device for the user to confirm. The user can confirm the information or make necessary modifications. The loan application page may further include information collection fields such as the amount of the loan, the reason for applying for the loan, payback plan, and so on. After the user provides the information and hits the “Apply” button, the loan request is sent from the user device to the platform through the Internet. After receiving the loan request, the platform saves the request in the database server and generates a loan application display page for other members of the system to search, browse, review, evaluate, comment on and vote on.

A member of the system may connect to the platform through the user device and Internet, and browse the pages on the platform. As multiple loan application records are stored in the database server, the member may send a filtering or sorting request to the platform so as to filter out the records that do match the filtering conditions, or sorting the records in a desired order. For example, the filtering condition may be ongoing applications, terminated applications and so on. The sorting may be based on the application filing date, the application expiration date, the amount of loan being applied for and etc. The platform is configured to respond to the filtering and sorting request, filter out the loan application records that do not match the filtering condition, and display the filtered records in the required order on the display of the user device. The member selects a record from the display and enters a loan application review page, from which the member can access the information about the applicant, the amount of the loan being applied for, payback date, and so on. The member can input inquiry or evaluation information on the page so as to get further details of the loan application or to evaluate the loan application and give comments. For example, if the member knows the applicant personally and finds the information on his application is false, the member can make certain comments, for example, reporting to the administrator by sending a message through a button “Report”. After the inquiry or evaluation is input by the member, the inquiry or evaluation is sent to the platform through the Internet. After receiving the inquiry or evaluation, the platform is configured to integrate such information into the loan application review page, and update the data of the whole page so that the updated loan application review page can be displayed. After that, a member can not only view the original information related to the loan application, but also browse the inquiry or evaluation made by other members earlier. The loan applicant may respond to the inquiry or evaluation in this page, or invite other members of the system to be his/her friends and approve the authenticity of the information in his/her loan application. The loan applicant may not only make text responses, but also respond to the inquiry or evaluation by uploading a video file. Similarly, the platform is configured to update the loan application review page, and integrate the responses from the loan applicant into the loan application review page. The platform may designate a specific loan examiner for all loan applications, or randomly appoint a specific loan examiner for each loan application. The loan examiner may interview the loan applicant and his/her friends in person or through an online video call, and then input the examiner's opinion into an opinion field in the loan application review page.

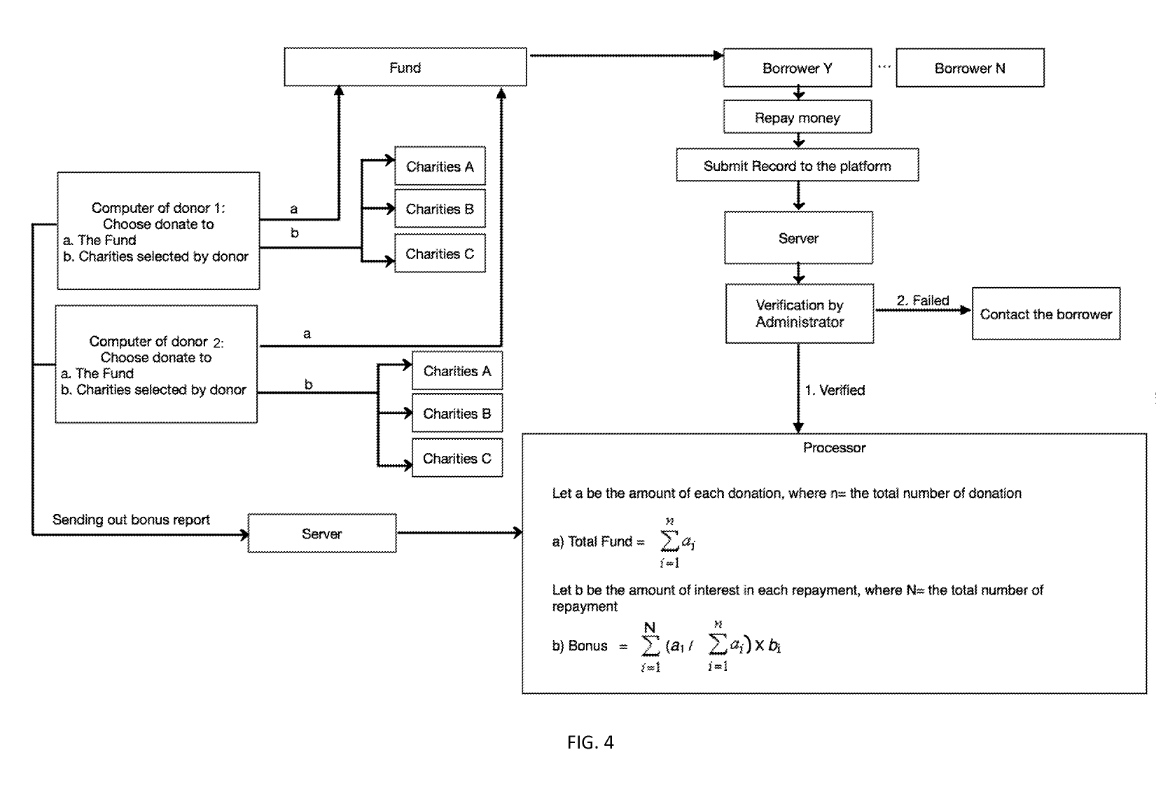

FIG. 4 illustrates a calculation system for distributing bonus among respective donors in the electronic donation management system depicted in FIG. 1A. Referring to FIG. 4, the borrowers repay through a bank or online methods. Besides paying back the loan principle, the borrower is normally required to pay back an additional amount of money as a bonus (or interest) for the donors. The distribution of the bonus between the donors is made based on the proportion of the donation made by each donor in the total amount of donations. The borrowers submit records to the platform. The server collects the records and the processor of the server processes the distribution of bonus monthly. The calculation is made according to the formula illustrated in FIG. 4. The donors receive reports every month on the platform through the Internet. The donors decide where the bonus will go. There are two options for a donor to dispose the bonus: 1) donating the bonus back to the fund; 2) donating to the charities that the donors select. In this embodiment, the processor is configured to distribute a bonus resulted from repayment by users with the borrower membership among users with the donor membership based on a total amount of donation and an amount of individual donation that each user with the donor membership contributes to the total amount. In addition, the borrowers are required to pay a service fee to the platform. The platform is configured to check the repayment record of the borrowers and confirm whether the borrowers have successfully repaid the loans. If a repayment is not made successfully, the platform is configured to notify the borrower and remind them to take appropriate actions.

FIG. 5 illustrates a public loan assessment process executed by the electronic donation management system depicted in FIG. 1A. Referring to FIG. 5, the public, i.e. users A, B, C, . . . , and Z, register as members and log in the platform. The users search for and select cases that they are interested in. When arriving at a specific loan page, the users study the information or ask questions. After reviewing the information, the users click the respective buttons to vote for “Approve/Agree” or “Disapprove/Disagree”. A pop-up window is prompted to ask for confirmation: if yes, the vote is recorded in the server; if no, the vote will be cancelled. All votes for “Approve” and “Disapprove” will be sent to and stored in the server. By the end of the voting period (one month for example), which is counted by a timer in the system, the processor of the server is configured to calculate the total number of votes. By fulfilling the following criteria, the application is approved:

Votes of “Approve” are more than:

20,000 votes for an application for USD $1-10,000;

200,000 votes for an application for USD $10,001-100.000;

Votes of “Disapprove” are NOT more than:

500 votes for an application for USD $1-10,000;

1,000 votes for an application for USD$10,001-100,000.

The system will automatically send an email to confirm with the applicant. In-person contact/face-to-face online contact may be conducted by administrators. In this embodiment, the processor is configured to count the number of votes approving the loan application and the number of votes disapproving the loan application, and to determine whether to approve the loan application according to a criteria based on the numbers. The criteria vary with the amount of loan being applied for in the loan application.

More specifically, when a system member presses an “Approve” button, the related approving data that carries “approval” information is sent to the platform through the user device and the Internet. When a system member presses a “Disapprove” button, the related disapproving data that carries “disapproval” information is sent to the platform through the user device and the Internet. Two accumulators are set up in the platform for each loan application, wherein a first accumulator is configured to accumulate the counts for approving data, while a second accumulator is configured to accumulate the counts for disapproving data. A timer is set up for each loan application, and configured to count down a voting period for the loan application. For example, the voting period may be set to be one month. The timer is started when a loan application page is generated, and will be expired after the predetermined voting period. After the timer is expired, the first and second accumulators stop accumulating the counts of approving and disapproving data respectively. The platform may be configured to update the loan application page and disable the voting button once the timer expires so that the loan application will not accept voting after the voting period.

It is understood that the rule for approving a loan application may take other forms. In one embodiment, after the voting period, only when the total votes is above a predetermined threshold, a decision can be made about whether to approve the loan application; otherwise, the timer can be reset so that the voting period is extended to collect a sufficient number of votes. After the voting result is generated, the platform informs the loan applicant of the voting result through email or SMS messages. If the voting result is approval, the platform will arrange a corresponding transfer from the fund account managed by the platform to the loan applicant's account, through an online payment gateway for example. If the voting result is disapproval, the platform is configured to delete the loan application review page for the loan application or expire the loan application review page, so that the loan application page does not accept the input of any new information, and the voting button therein does not respond to any action. The platform is configured to update the record for the loan applicant in the database server, which includes the fields of application date, amount, voting result and so on. If the applicant only has one loan application, after the voting results turns out to be disapproval, the platform is configured to mark the field of the applicant's identity to be ordinary member.

According to another embodiment of the present patent application, an electronic donation management method includes: generating a website and a mobile application with a platform; receiving donation and loan related data from a plurality of users and sending the data to a server with the platform; storing the data, granting appropriate memberships to the users respectively, and activating functions that correspond to the memberships for the users respectively with the server; and making calculations based on the data and making donation and loan related decisions according to the calculations with a processor of the server. The platform is in communication with the server, connected with the Internet, and accessible to a plurality of users through the Internet.

The electronic donation management method may further include activating one or multiple memberships for each user among a donor membership, a borrower membership, and an ordinary member membership with the server; generating a donation interface on the platform with the server, the donation interface being configured to accept a donation payment from a user through an online payment gateway; granting the user the donor membership and sending the user a monthly report on a repayment record and a bonus that the user has gained with the server; generating a loan interface with the server, the load interface being configured to accept a loan application from a user; granting the user the borrower membership and allowing other users to search and vote on the loan application with the server; counting the number of votes approving the loan application and the number of votes disapproving the loan application and determining whether to approve the loan application according to a criteria based on the numbers with the processor, the criteria varying with the amount of loan being applied for in the loan application; and distributing a bonus resulted from repayment by users with the borrower membership among users with the donor membership based on a total amount of donation and an individual donation that each user contributes to the total amount with the processor.

In above embodiments, through the electronic donation management system and method, donation from donors can be received. Loan applications can be received. The application approval process is participated by the public (members of the online community). A loan application can be approved by gaining supports from the public. The borrower repays the debt according to the schedule he/she sets, without legal binding regulations. The principle received goes back to the fund, the bonus (interest) received goes to the donors, and a service fee goes to an operator of the system according to respective proportions set by the borrowers. Therefore, through the electronic donation management system and method, donation and loan management is fast and effectively achieved.

While the present patent application has been shown and described with particular references to a number of embodiments thereof, it should be noted that various other changes or modifications may be made without departing from the scope of the present invention.

What is claimed is:

1. An electronic donation management system comprising:
a server, the server comprising a processor; and
a platform in communication with the server, the platform being connected with the Internet and accessible to a plurality of users through the Internet; wherein:
the platform is a web application being configured to generate a website and a mobile application;
the platform is configured to receive donation and loan related data from the users and send the data to the server;
the server is configured to store the data, to grant appropriate memberships to the users respectively, and to activate functions that correspond to the memberships for the users respectively; and
the processor is configured to make calculations based on the data and make donation and loan related decisions according to the calculations.

2. The electronic donation management system of claim 1, wherein the server is configured to activate one or multiple memberships for each user among a donor membership, a borrower membership, and an ordinary member membership.

3. The electronic donation management system of claim 2, wherein the server is configured to generate a donation interface on the platform, the donation interface being configured to accept a donation payment from a user through an online payment gateway.

4. The electronic donation management system of claim 3, wherein the server is configured to grant the user the donor membership, send the user a monthly report on a repayment record and a bonus that the user has gained, and send the user a real-time record of repayments and bonus gained from the donation that the user has made.

5. The electronic donation management system of claim 2, wherein the server is configured to generate a loan application interface, the load application interface being configured to accept a loan application from a user.

6. The electronic donation management system of claim 5, wherein the server is configured to grant the user the borrower membership, and to allow other users to search and vote on the loan application.

7. The electronic donation management system of claim 6, wherein the processor is configured to count the number of votes approving the loan application and the number of votes disapproving the loan application, and to determine whether to approve the loan application according to predetermined criteria based on the numbers.

8. The electronic donation management system of claim 7, wherein the predetermined criteria vary with the amount of loan being applied for in the loan application.

9. The electronic donation management system of claim 2, wherein the processor is configured to distribute a bonus resulted from repayment by users with the borrower membership among users with the donor membership based on a total amount of donation and an amount of individual donation that each user with the donor membership contributes to the total amount.

10. An electronic donation management method comprising:
generating a web site and a mobile application with a platform;
receiving donation and loan related data from a plurality of users and sending the data to a server with the platform;
storing the data, granting appropriate memberships to the users respectively, and activating functions that correspond to the memberships for the users respectively with the server; and
making calculations based on the data and making donation and loan related decisions according to the calculations with a processor of the server; wherein:
the platform is in communication with the server, connected with the Internet, and accessible to a plurality of users through the Internet.

11. The electronic donation management method of claim 10 further comprising activating one or multiple memberships for each user among a donor membership, a borrower membership, and an ordinary member membership with the server.

12. The electronic donation management method of claim 11 further comprising generating a donation interface on the platform with the server, the donation interface being configured to accept a donation payment from a user through an online payment gateway.

13. The electronic donation management method of claim 12 further comprising granting the user the donor membership, sending the user a monthly report on a repayment record and a bonus that the user has gained with the server, and sending the user a real-time record of repayments and bonus gained from the donation that the user has made.

14. The electronic donation management method of claim 11 further comprising generating a loan interface with the server, the load interface being configured to accept a loan application from a user.

15. The electronic donation management method of claim 14 further comprising granting the user the borrower membership and allowing other users to search and vote on the loan application with the server.

16. The electronic donation management method of claim 15 further comprising counting the number of votes approving the loan application and the number of votes disapproving the loan application and determining whether to approve the loan application according to predetermined criteria based on the numbers with the processor.

17. The electronic donation management method of claim 16, wherein the predetermined criteria vary with the amount of loan being applied for in the loan application.

18. The electronic donation management method of claim 11 further comprising distributing a bonus resulted from repayment by users with the borrower membership among users with the donor membership based on a total amount of donation and an amount of an individual donation that each user with the donor membership contributes to the total amount with the processor.

19. An electronic donation management system comprising:
a server, the server comprising a processor; and
a platform in communication with the server, the platform being connected with the Internet and accessible to a plurality of users through the Internet; wherein:
the platform is a web application being configured to generate a website and a mobile application;
the platform is configured to receive donation and loan related data from the users and send the data to the server;
the server is configured to store the data, to grant appropriate memberships to the users respectively, to activate functions that correspond to the memberships for the users respectively, and to allow one user to send a friend request to another user;
the processor is configured to make calculations based on the data and make donation and loan related decisions according to the calculations; and
the donation and loan related decisions comprise whether to approve a loan application filed by a borrower, and how to distribute a bonus from a loan among a plurality of donors.

20. The electronic donation management system of claim 19, wherein the server is configured to accept a loan application from a user through a loan application interface and to allow other users to vote on the loan application, and the processor is configured to count the number of votes approving the loan application and the number of votes disapproving the loan application and to determine whether to approve the loan application according to a criteria based on the numbers.
